(19) United States
(12) Patent Application Publication
(10) Pub. No.: US 2024/0003717 A1
(43) Pub. Date: Jan. 4, 2024

(54) NOVEL AI-DRIVEN APPROACH TO DETECT ADN LOCALIZE VEHICLE EMERGENCY STOPS BASED ON VEHICLE TRAJECTORY USING DISTRIBUTED FIBER OPTIC SENSING (DFOS) DATA

(71) Applicant: NEC Laboratories America, Inc., Princeton, NJ (US)

(72) Inventors: Milad SALEMI, Cross River, NY (US); Ming-Fang HUANG, Princeton, NJ (US); Yuheng CHEN, South Brunswick, NJ (US); Shaobo HAN, Princeton, NJ (US)

(73) Assignee: NEC Laboratories America, Inc., Princeton, NJ (US)

(21) Appl. No.: 18/320,993

(22) Filed: May 21, 2023

Related U.S. Application Data
(60) Provisional application No. 63/344,109, filed on May 20, 2022.

(51) Int. Cl. G01D 5/353; G01H 9/00; G06N 3/09

(52) U.S. Cl. CPC G01D 5/35361; G06N 3/09; G01H 9/004

(57) ABSTRACT

A DFOS system and method providing detection and localization of vehicle emergency stops which employs DFOS and machine learning techniques as an integrated solution for automatic, real-time, detection and localization of vehicle emergency stop events. Real time-location data from a buried optical sensing fiber located along a roadway is used to derive continuous vehicle trajectories while providing a wide coverage area for more accurate assessments. AI techniques are employed which track vehicles' speed and acceleration, locate vehicle deceleration events, and localize emergency stop events. Danger assessment is determined by analyzing a vehicle's anticipated and reproducible trajectory after an emergency breaking event—while ignoring stop-and-go events as low-risk events—and discovering stop-no-go events exhibiting large deceleration as high-risk events.

### CROSS-REFERENCE TO RELATED APPLICATIONS

This application claims the benefit of U.S. Provisional Patent Application Ser. No. 63/344,109 filed May 20, 2022, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to artificial intelligence (AI) based DFOS systems and methods providing detection and localization of vehicle emergency stops.

### BACKGROUND OF THE INVENTION

Distributed fiber optic sensing (DFOS) technologies including Distributed Acoustic Sensing (DAS), Distributed Vibration Sensing (DVS), and Distributed Temperature Sensing (DTS) are known to be quite useful for sensing acoustic events, vibrational events, and temperatures in a plethora of contemporary applications. Known further, traffic incidents and accidents cause both traffic disruptions and loss of life. Many traffic accidents are preceded by an unsuccessful breaking attempt by a driver. As such, emergency stop patterns may prove a useful indication of early-stage road incidents. Such indication is more important when an incident occurs in a remote area, where first-responder response times may be most critical.

### SUMMARY OF THE INVENTION

The above problem is solved and an advance in the art is made according to aspects of the present disclosure directed to artificial intelligence (AI) based DFOS systems and methods providing detection and localization of vehicle emergency stops.

In sharp contrast to the prior art, our inventive systems and methods employ DFOS and machine learning techniques as an integrated solution for automatic, real-time, detection and localization of vehicle emergency stop events.

Viewed from a first aspect, our inventive DFOS systems provide time-location data from a buried optical sensing fiber located along a roadway and derive continuous vehicle trajectories while providing a wide coverage area for more accurate assessments.

Viewed from another aspect, our inventive DFOS systems employ AI techniques that track vehicles' speed and acceleration, locate vehicle deceleration events, and localize emergency stop events.

Finally, viewed from yet another aspect, our inventive DFOS systems provide danger assessment by analyzing a vehicle's anticipated and reproducible trajectory after an emergency break while ignoring stop-and-go events as low-risk events, and discovering stop-no-go events exhibiting large deceleration as high-risk events.

### BRIEF DESCRIPTION OF THE DRAWING

FIG. 1(A) and FIG. 1(B) are schematic diagrams showing an illustrative prior art uncoded and coded DFOS systems;

FIG. 2. Is a schematic diagram showing an illustrative system setup for a DFOS system with AI engine/analyzer according to aspects of the present disclosure;

FIG. 3 are a series of plots showing a) random noisy distributions; b) noise applied to intensities in each row; and c) randomized intensities projected to analytically determined positions according to aspects of the present disclosure;

FIG. 4(A), FIG. 4(B), FIG. 4(C), and FIG. 4(D) are plots illustrating designed emergency stop templates for: FIG. 4(A) breaking speed 40 km/h, deceleration 4 m/s**2; FIG. 4(B) breaking speed 130 km/h, deceleration m/s**2; FIG. 4(C) breaking speed 60 km/h, deceleration 9 m/s**2; and FIG. 4(D) breaking speed 90 km/h, deceleration 5 m/s**2; according to aspects of the present disclosure;

FIG. 5 is a schematic diagram showing illustrative process of template matching to find emergency stop vehicle trajectory in an input waterfall data according to aspects of the present disclosure;

FIG. 6 is a diagram showing illustrative sample of templates synthetically generated using our inventive procedure according to aspects of the present disclosure;

FIG. 7(A) and FIG. 7(B) are a pair of diagrams showing an illustrative example of detected emergency event in which FIG. 7(A) shows received sensing data and FIG. 7(B) shows an activation map according to aspects of the present disclosure; and

FIG. 8 is a schematic diagram showing illustrative operations including template design, event detection, and event localization and reporting according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

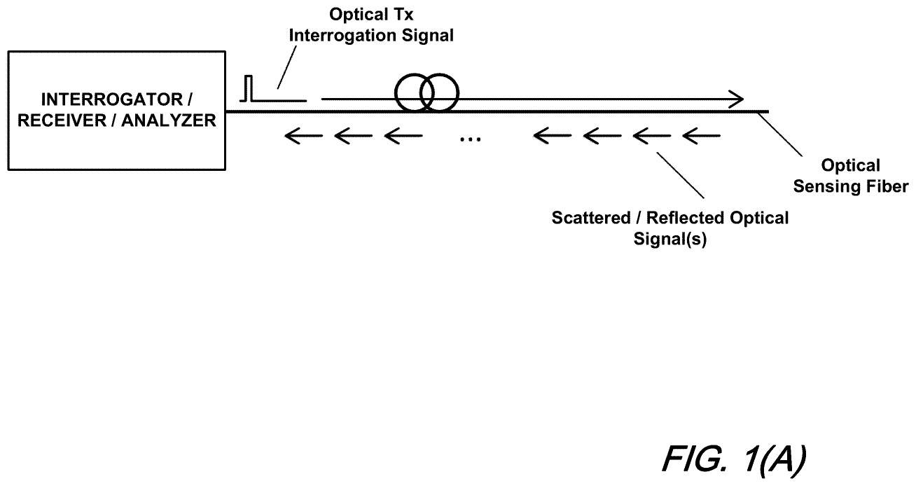

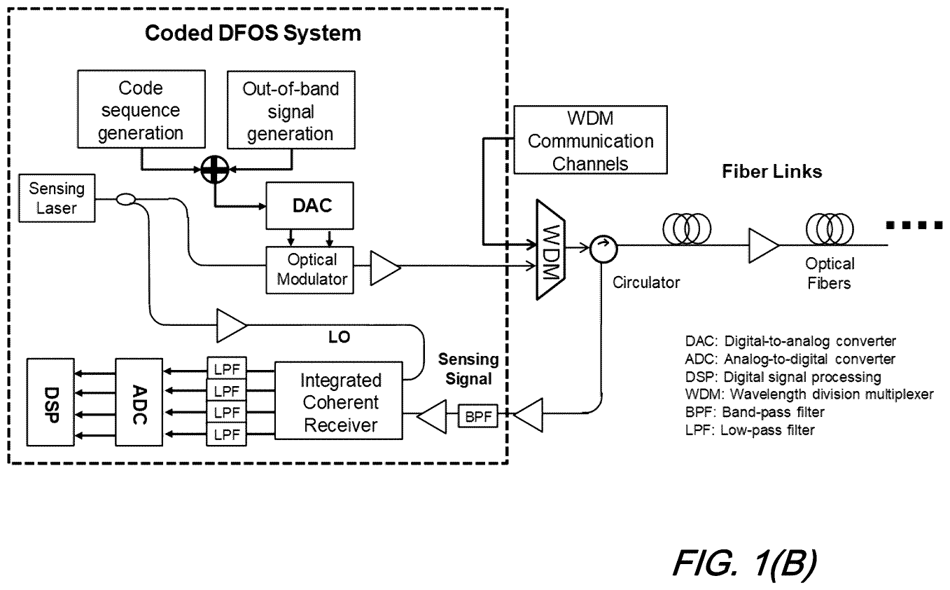

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

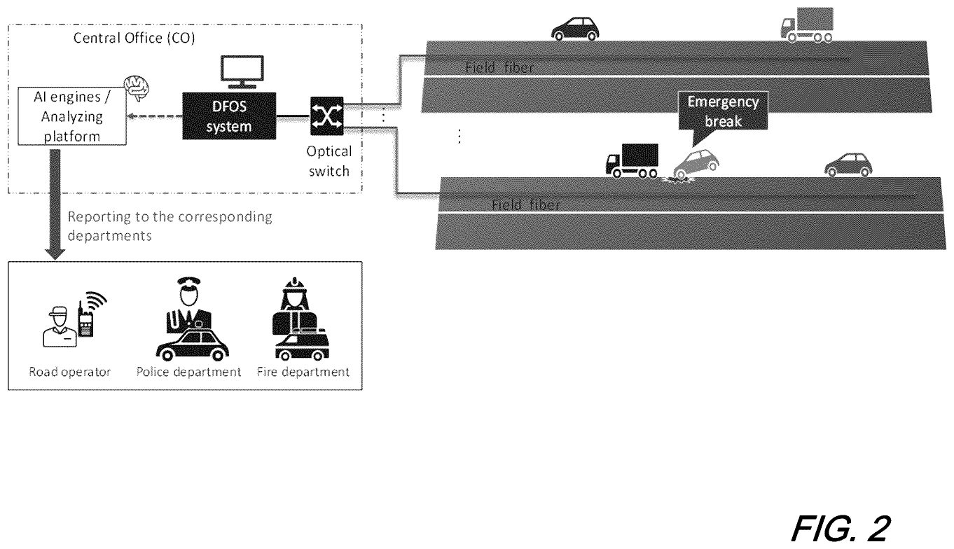

FIG. 2. Is a schematic diagram showing an illustrative system setup for a DFOS system with AI engine/analyzer according to aspects of the present disclosure. With reference to that figure, we note that our systems and methods may use existing deployed optical fiber such as those already deployed along highways and roadways for traffic surveillance cameras and data transmission. Note that according to an aspect of the present disclosure, DFOS operations, which advantageously can be either distributed acoustic sensing (DAS) or distributed vibration sensing (DVS), is set up in the control office/central office (CO) for remote monitoring of an entire optical sensor fiber route. The DFOS system is shown integrated with an optical switch and connected to a pair of optical sensor fibers to provide sensing functions along multiple fiber routes. The optical fibers can be a dark fiber or operational fiber carrying live telecommunications (or other) traffic. After an event is detected, an alarm is triggered and danger assessment is reported to responsible entities such as traffic control office, police, and fire departments.

Operationally, our inventive method proceeds as follows:

Step 1: Emergency Stop Template Design

Design elements/variables include:

Vehicle speed at the break moment: the speed of the vehicle just before the driver starts breaking.

Break deceleration: the negative acceleration that governs speed reduction.

Tire-Road friction coefficient: depending on the road surface-tire friction properties vehicle stop trajectory is affected. Slippery road conditions such wet or icy surfaces affect the trajectory.

Extent: the length of the optical sensor fiber affected by the source of vibration.

Intensity: the intensity level of the vibration at each time step.

Intensity distribution: assuming a symmetrical distribution from the middle of the vibration extent to the left and right.

Scale: the standard deviation of the assumed normal distribution for intensity.

Noise: adding noise to each point of the intensity distribution to emulate variations due to ground conditions and wave propagation path.

The spatial resolution of the sensing system and the time step for each newly received row of data must be considered in the template design process. It is possible to scale up or down a template. This process would be analogous to resizing a picture by increasing or reducing its resolution.

To generate a template, a vehicle speed before emergency breaking needs to be assumed. Additionally, depending on the break force applied by the driver, a range of deceleration values are possible, and hence different combination of templates are required.

According to the kinematics, equation of motion for an object in one dimension is:

$$x = \frac{1}{2} {at}^{2} + {v}_{0} t + {x}_{0} ;$$

$$v = at + {v}_{0}$$

where x is the location of the object with a speed of v at time t which is moving with the constant acceleration of a and started its motion from location x₀ with an initial speed of v₀.

Manipulating this equation for an emergency stop (v=0) and starting from a reference location (x₀=0), total time, t_{S}, and distance traveled, x_{S}, before full stop can be calculated

$${t}_{S} = - \frac{{v}_{0}}{a}$$

$${x}_{S} = \frac{1}{2} {at}_{S}^{2} + {v}_{B} {t}_{S}$$

The above equations provide the entire vehicle travel trajectory during breaking and before a full stop at every time step. The breaking trajectory is then used to design various templates to emulate the real behavior. In other words, the break trajectory emulates sensing data collected by the DFOS system while a real vehicle was observed during an emergency breaking event.

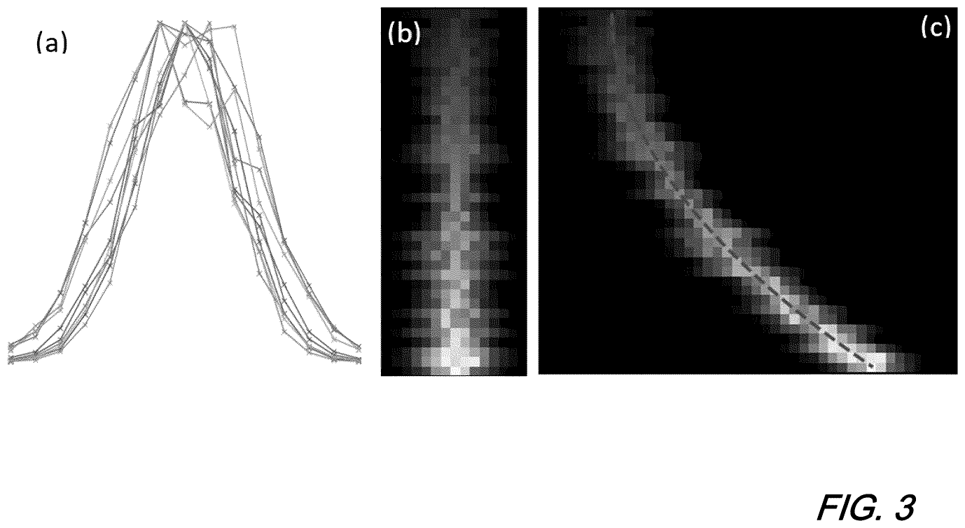

FIG. 3 is a series of plots showing a) random noisy distributions; b) noise applied to intensities in each row; and c) randomized intensities projected to analytically determined positions according to aspects of the present disclosure.

Few samples of random distributions that are applied to intensity extent of vibration at each row (representing a time step) are shown in FIG. 3(A). FIG. 3(C) displays the random noise applied intensities in each row which are reduced with time steps corresponding to each row. Randomized intensities are then projected to the positions that are governed by break trajectory shown in green dashed curve as exhibited in FIG. 3(C).

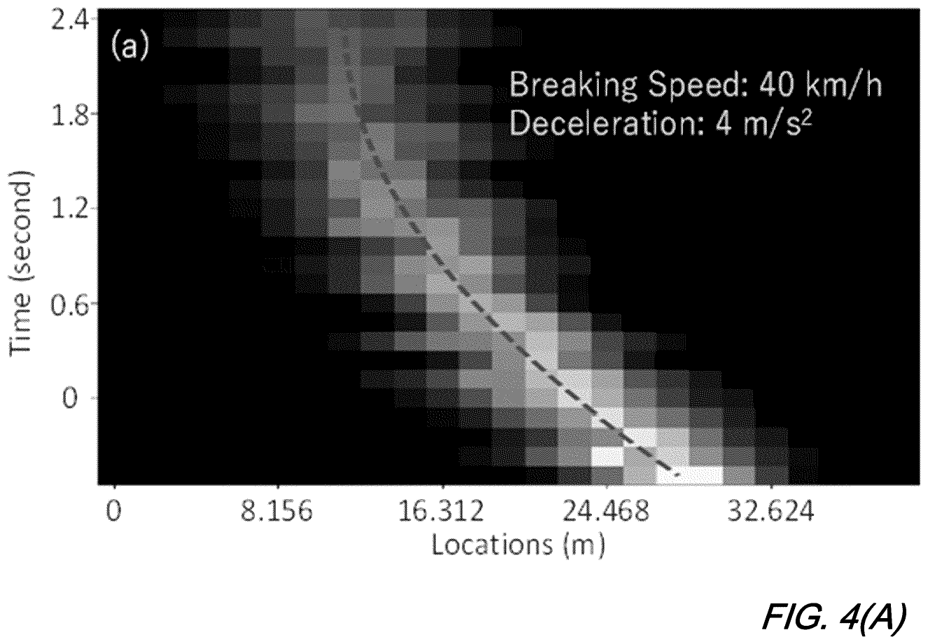

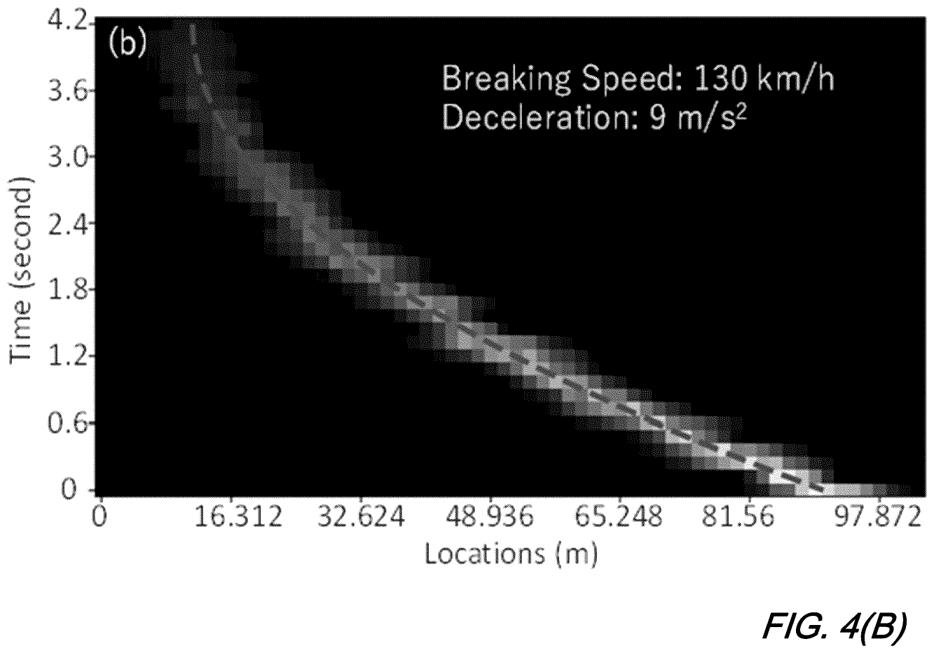

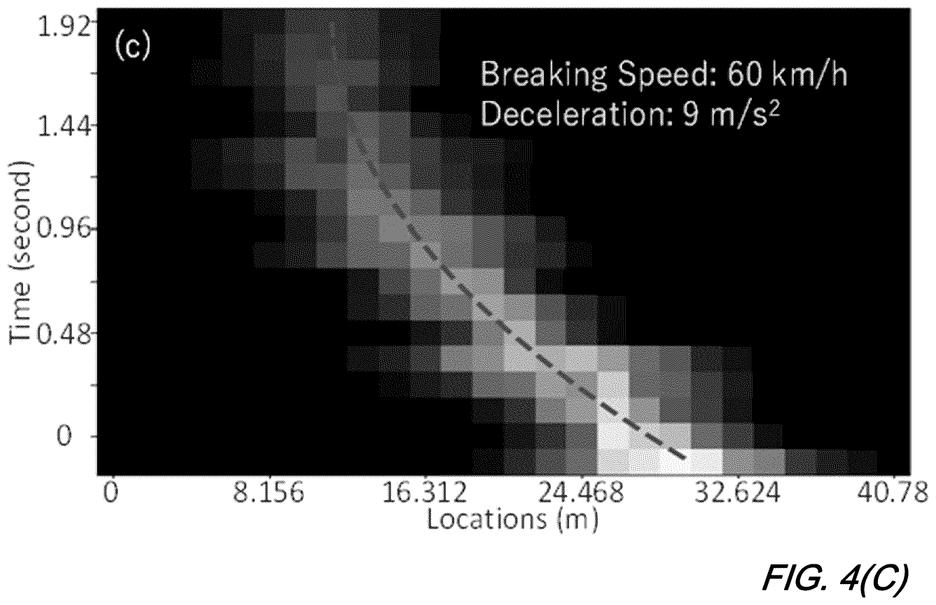

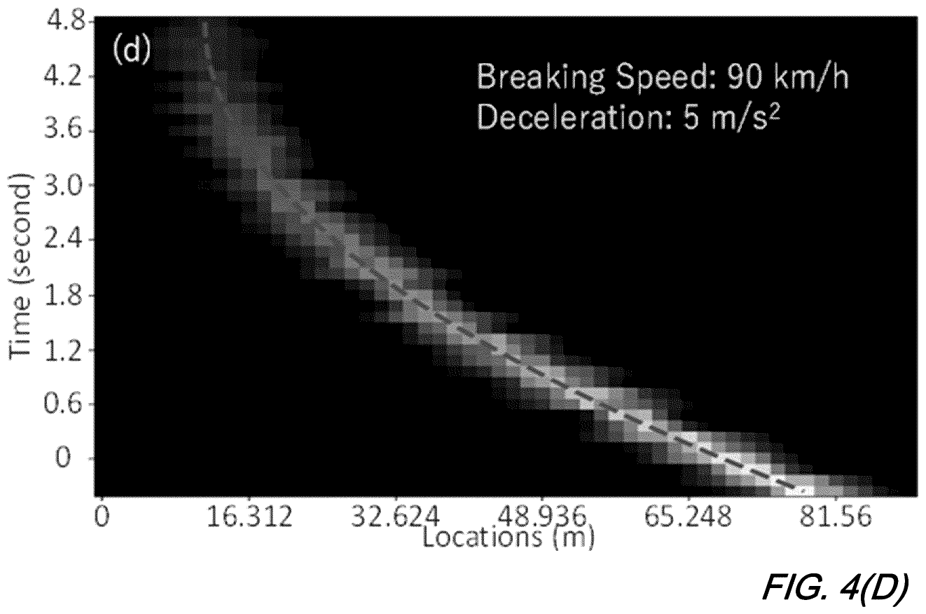

FIG. 4(A), FIG. 4(B), FIG. 4(C), and FIG. 4(D) are plots illustrating designed emergency stop templates for: FIG. 4(A) breaking speed 40 km/h, deceleration 4 m/s**2; FIG. 4(B) breaking speed 130 km/h, deceleration m/s**2; FIG. 4(C) breaking speed 60 km/h, deceleration 9 m/s**2; and FIG. 4(D) breaking speed 90 km/h, deceleration 5 m/s**2; according to aspects of the present disclosure.

As shown in this figure, are some examples of the designed and synthetically generated emergency stop templates with different breaking speeds and decelerations. The overlayed dash line represents the analytical trajectory of the vehicle motion from t=0 to the time at full stop (where dash line is approaching to tangent the vertical asymptote).

Step 2: Event Detection Procedure

Depending on the application and scope of the work, two separate approaches may be taken:

Template Matching

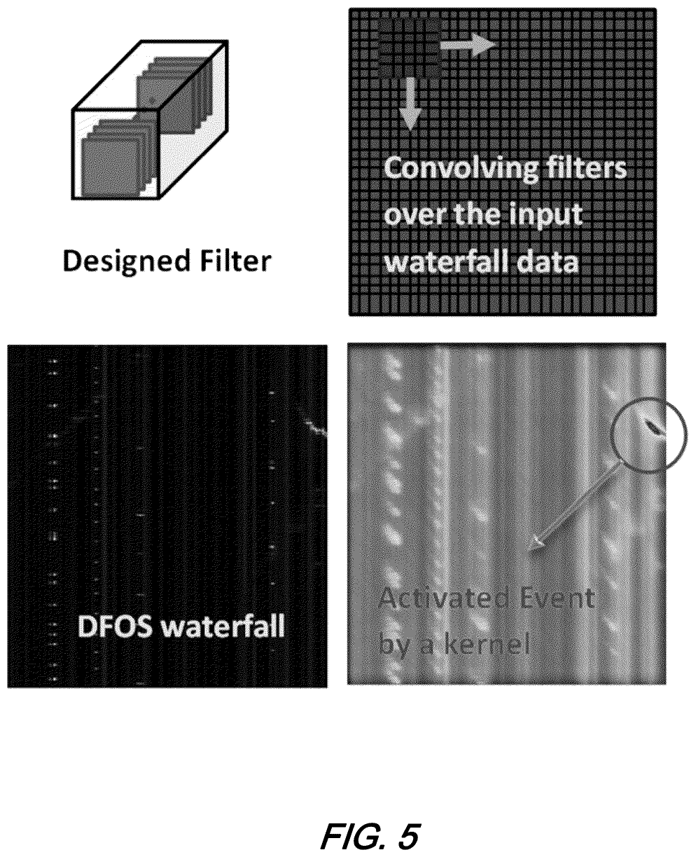

This approach is more suited to detect more specific scenarios within well-known parameters of vehicles. Designed templates will be reshaped to the same dimensions and stacked as kernels of a larger filter. The filter is then convolved with the input waterfall to activate existing events of interest in the waterfall. This process is visualized in FIG. 5 which is a schematic diagram showing illustrative process of template matching to find emergency stop vehicle trajectory in an input waterfall data according to aspects of the present disclosure.

Training a Generalized Model

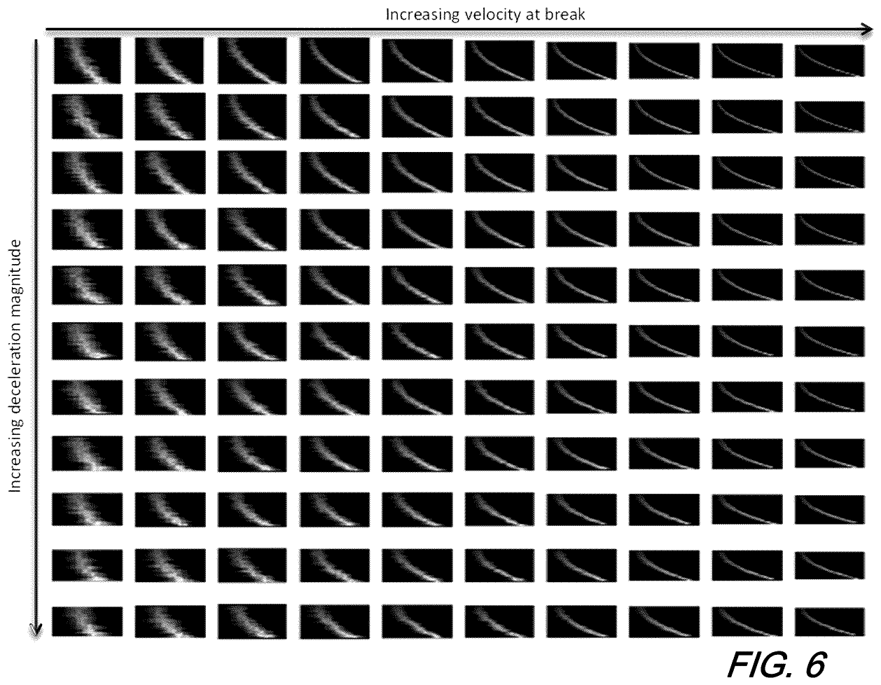

In this approach, the proposed procedure can be used to generate a database comprising thousands of synthetic examples for various vehicle stop conditions by tuning the design parameters introduced earlier. Each example may be labeled qualitatively or qualitatively depending on the preferred reporting, to activate proper events within an input waterfall data. A neural network model is then trained using the synthetic database to detect a wide range of events. This generalized model could be utilized in various field conditions with minimal tuning requirements. Generalization of the model relies on the size of the synthetic database. FIG. 6 is a diagram showing illustrative sample of templates synthetically generated using our inventive procedure according to aspects of the present disclosure.

Step. 3 Event Localization and Reporting:

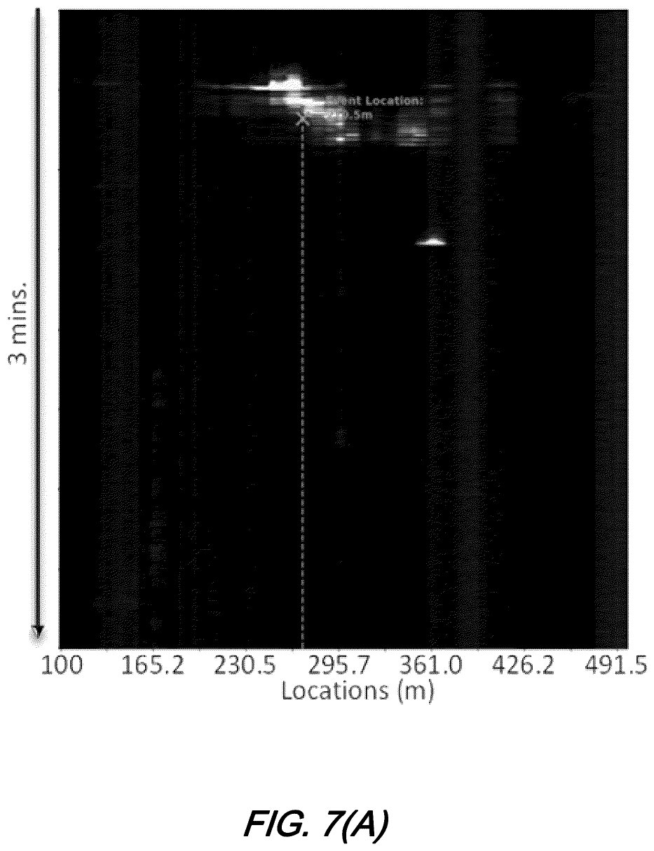

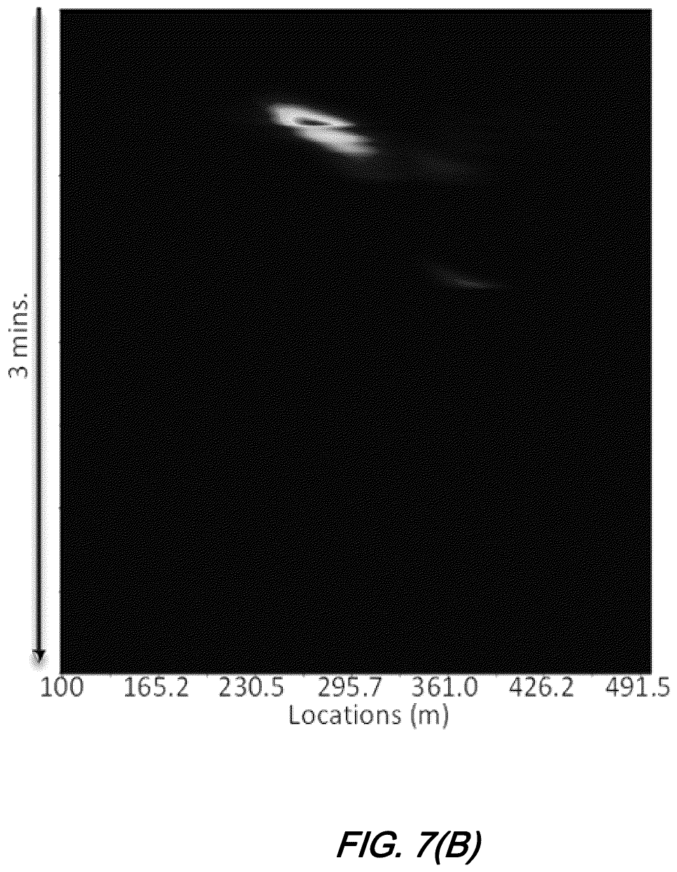

FIG. 7(A) and FIG. 7(B) are a pair of diagrams showing an illustrative example of detected emergency event in which FIG. 7(A) shows received sensing data and FIG. 7(B) shows an activation map according to aspects of the present disclosure. As shown in this figure, is an example of a detected emergency stop event in the field. FIG. 7 (A) shows the received sensing data and pinpointed the event location at 270.5 m (about 887.47 ft) by the AI engines. Additionally, event activation is visualized in FIG. 7 (B).

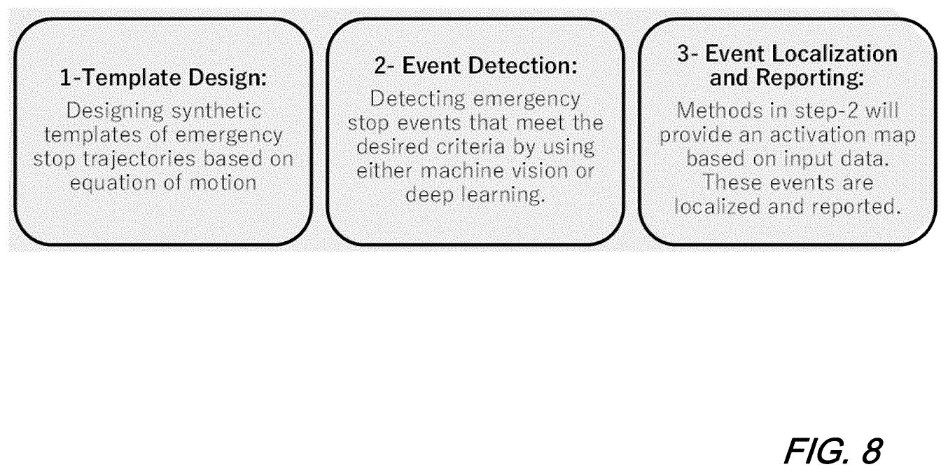

FIG. 8 is a schematic diagram showing illustrative operations including template design, event detection, and event localization and reporting according to aspects of the present disclosure.

At this point, while we have presented this disclosure using some specific examples, those skilled in the art will recognize that our teachings are not so limited. Accordingly, this disclosure should only be limited by the scope of the claims attached hereto.

1. A method for detecting and localizing vehicle emergency stops using distributed fiber optic sensing (DFOS), the method comprising:
providing the DFOS system including:
a length of optical sensing fiber located adjacent to a highway carrying vehicle traffic such that it senses highway vibrational activity;
an optical interrogator configured to generate optical pulses, introduce the generated optical pulses into the optical sensing fiber and receive Rayleigh reflected signals from the optical sensing fiber;
an artificial intelligence (AI) analyzer configured to analyze the Rayleigh reflected signals received by the optical interrogator and determine emergency stops made by vehicles traveling on the highway;
detecting, an emergency stop event determined by an event detection procedure selected from the group consisting of: template matching, and generalized model training;
localizing, a location of the emergency stop event along the length of the optical sensing fiber; and
reporting the occurrence of and the location of the emergency stop event.

2. The method of claim 1 wherein the received Rayleigh reflected signals are organized into an input waterfall image and the template matching includes reshaping designed filters to a same dimension and stacked as kernels of a larger filter which is then convolved with input the waterfall image, activating existing events of interest in the input waterfall image.

3. The method of claim 1 further comprising generating a database comprising a plurality of synthetic examples of various vehicle stop conditions and training a neural network model using the synthetic database.

4. The method of claim 3 wherein the various vehicle stop conditions include: vehicle speed at a braking moment, tire-road friction coefficient, length of the optical sensing fiber affected by vibrations produced by a vehicle stop condition, intensity of vibrations produced by a vehicle stop condition at a plurality of times, and noise.

5. The method of claim 3 further comprising determining a travel trajectory for a vehicle during a braking operation and before a full stop at a plurality of times, and using the travel trajectory to design templates.
